(19) United States
(12) Patent Application Publication
(10) Pub. No.: US 2008/0311275 A1
(43) Pub. Date: Dec. 18, 2008

(54) ALCOHOL-CONTAINING WASABI, WASABI EXTRACT SOLUTION AND WASABI EXTRACT

(75) Inventors: Taiichi Kamegai, Shizuoka (JP); Shigeyoshi Miyashiro, Shizuoka (JP); Kiyoshi Kamegai, Shizuoka (JP); Ken Kamegai, Shizuoka (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KAMEYA FOOD CO., LTD., Mishima-shi (JP)

(21) Appl. No.: 11/761,807

(22) Filed: Jun. 12, 2007

(51) Int. Cl. A23L 1/221

(52) U.S. Cl. 426/638

(57) ABSTRACT

The present invention provides an alcohol-containing wasabi, a wasabi extract solution and a wasabi extract capable of stably maintaining flavor and pungent taste of freshly harvested wasabi for a long period of time.

The alcohol-containing wasabi is prepared by impregnating wasabi with alcohol. The method for obtaining the alcohol-containing wasabi comprises the steps of impregnating the mass of wasabi with alcohol by permitting wasabi to contact alcohol or an alcohol aqueous solution, and allowing wasabi to stand for 20 minutes or more at a temperature from 5 to 60° C. The wasabi extract solution is obtained by distilling of the alcohol-containing wasabi. The wasabi extract is obtained by diluting the wasabi extract solution with water to an alcohol concentration of 30% by weight or less to form precipitates, and by filtering the precipitate.

### BACKGROUND OF THE INVENTION

1. Field of the Invention

The invention relates to an alcohol-containing wasabi (Japanese horseradish), a wasabi extract solution and a wasabi extract that can stably exhibit flavor and pungent taste of freshly harvested wasabi for a long period of time.

2. Description of the Related Art

Horseradish such as wasabi (Japanese horseradish), taking advantage of its unique flavor and pungent taste, has been widely used as seasoning or spices of dishes by being grated or pickled. However, wasabi has a character that its freshness starts to be deteriorated immediately after harvest and its flavor and pungent taste are readily lost. For example, freshness of wasabi is lost in about 1 week even by chilled storage, and the flavor and pungent taste of freshly harvested wasabi are lost in a short period of time.

For long term preservation of the unique flavor and pungent taste of wasabi, processed wasabi obtained by pulverizing wasabi with additives has been developed (see Patent Document 1).

For permitting the flavor and pungent taste unique to wasabi to be exhibited, enzymatic reactions should be made to start and advance. In other words, a substrate (sinigrin) as a source of pungent taste is allowed to react with an enzyme (myrosinase) so as to change the substrate into a pungent taste substance. The substrate and enzyme are located at different cites in wasabi. Accordingly, the substrate and enzyme are usually made to contact to one another by mixing them by grating the wasabi when the flavor and pungent taste peculiar to wasabi are displayed. In an industrial process, the reaction between the substrate and enzyme can be initiated and advanced by mechanically pulverizing wasabi as described above.

However, since freshness of wasabi begins to be lost from immediately after harvest as described above, the harvested wasabi should be immediately processed and grated as finely as possible in order to permit the flavor and pungent taste of wasabi to be exhibited at the maximum in conventional processed products of wasabi. In other words, since the processing time from harvest to grating is required to be as short as possible, this requirement has imposed a great barrier on the industrial production of the processed product of wasabi. It has been another problem in the above mentioned conventional processed products of wasabi that the appearance as processed food materials is restricted due to the requirement of fracture of wasabi by grating.

Other examples of the processed product of wasabi that has been industrially produced and sold in the market include synthetic allyl isothiocyanate that is a major component of flavor and pungent taste of wasabi and pungent taste extracts of horseradish. However, the flavor and pungent taste of such synthetic products and pungent taste extracts have been far from the flavor and pungent taste of wasabi (Wasabia japonica)
[Patent Document 1] Jp 1991-67559 Unexamined Patent Publication (Kokai)

### SUMMARY OF THE INVENTION

The present invention has been accomplished in views of the above-described conventional problems and an object of the present invention is to provide an alcohol-containing wasabi, a wasabi extract solution and a wasabi extract that can stably maintain the flavor and pungent taste of freshly harvested wasabi for a long period of time.

A first aspect of the present invention is an alcohol-containing wasabi prepared by impregnating wasabi with alcohol.

The alcohol-containing wasabi according to the first aspect of the present invention is prepared by impregnating wasabi with an alcohol as described above. The alcohol-containing wasabi prepared by impregnation of an alcohol can maintain its freshness for long period of time, for example, for 10 days or more even when it is stored at room temperature without being decayed or generating bad smell. Flavor and pungent taste of the alcohol-containing wasabi can be maintained for a long period of time of 1 month or more by being stored in a sealed vessel in a refrigerator.

The alcohol-containing wasabi can generate flavor and pungent taste unique to wasabi without being grated or pulverized. This may be appreciated that the reaction between the substrate as a source of pungent taste of wasabi and enzyme starts and proceeds by the action of alcohol in the alcohol-containing wasabi. The alcohol-containing wasabi can exhibit stronger flavor and pungent taste by being grated and pulverized, and the flavor and pungent taste can be maintained for a long period of time.

Accordingly, the alcohol-containing wasabi can be stored until it is processed into known processed products of wasabi such as grated wasabi and pickled wasabi, and flavor and pungent taste unique to wasabi can be maintained during the storage. Consequently, processed products of wasabi that maintain the flavor and pungent taste of freshly harvested wasabi can be produced by using the alcohol-containing wasabi.

Since pungent taste has been already expressed in the alcohol-containing wasabi, there arises no problem even if the enzyme that induces the pungent taste is inactivated in processing. Accordingly, alcohol-containing wasabi is compatible with processed products that require a treatment by which the enzyme tends to be inactivated during the production process such as pickling and processing at high temperatures.

The alcohol-containing wasabi can exhibit flavor and pungent taste without mechanical pulverization or the like as described above. Accordingly, the alcohol-containing wasabi can be used by being processed into various forms other than pulverized products.

As described above, according to the first aspect of the present invention, the alcohol-containing wasabi that can stably maintain flavor and pungent taste of freshly harvested wasabi for a long period of time.

A second aspect of the present invention is a wasabi extract solution obtained by distilling the alcohol-containing wasabi according to the first aspect of the invention.

The wasabi extract solution of the second aspect of the present invention is prepared by distilling the alcohol-containing wasabi according to the first aspect of the present invention which contains flavor and pungent taste more abundantly than harvested wasabi. Since the alcohol-containing wasabi contains alcohol, flavor components and pungent taste components abundantly contained in alcohol-containing wasabi are readily extracted into the extract solution together with alcohol during distillation.

Accordingly, the wasabi extract solution contains high concentrations of the flavor component and pungent taste component that serve as the sources of flavor and pungent taste of wasabi. Consequently, the wasabi extract solution can stably maintain flavor and pungent taste of freshly harvested wasabi for a long period of time.

A third aspect of the present invention is a wasabi extract obtained by the steps comprising:

forming precipitates by diluting the wasabi extract solution with water to an alcohol concentration of 30 wt % or less; and

retrieving the precipitate.

The wasabi extract solution of the second aspect of the present invention contains high concentrations of the flavor component and pungent taste component of wasabi. The flavor component and pungent taste component precipitate by diluting the wasabi extract solution with water to an alcohol concentration of 30% by weight or less.

Accordingly, the extract obtained by retrieving the precipitate by, for example, filtration abundantly contains the flavor component and pungent taste component of wasabi. Consequently, the extract can stably maintain flavor and pungent taste of freshly harvested wasabi for a long period of time.

### DETAILED DESCRIPTION OF THE PREFERRED EMBODIMENTS

The embodiment of the present invention will be described below.

The alcohol-containing wasabi in the present invention is prepared by impregnating wasabi with alcohol. The alcohol-containing wasabi can be produced simply by permitting wasabi to contact alcohol or an alcohol aqueous solution.

As the alcohol, hydrophilic lower primary alcohols such as methanol and ethanol is available.

It is preferable that the alcohol is ethanol.

In this case, safety of the alcohol-containing wasabi and processed foods produced using the alcohol-containing wasabi may be improved by taking advantage of high safety of ethanol approved as a food additive.

It is preferable that the wasabi belongs to Wasabia japonica and the wasabi is an entire body or a tissue divided into at least one portion selected from flowers, leaves, stems, rootstocks and roots.

In this case, the alcohol-containing wasabi can stably exhibit flavor and pungent taste having cool sense unique to Wasabia japonica for a long period of time.

The contact between alcohol or alcohol aqueous solution and wasabi can be performed by spraying, soaking, mixing with stirring, or the like.

The concentration and amount of use of alcohol in contact with wasabi can be appropriately selected by calculating the amount of alcohol to be impregnated into wasabi. The contact between wasabi and alcohol aqueous solution can be performed, for example, from 1 to 60 minutes. Alcohol can be transferred into the mass of wasabi during this contact time with an amount of impregnation of 50 wt % or more in wasabi. Alcohol remains in the mass of wasabi even after the contact time exceeds 60 minutes.

The content of alcohol in the alcohol-containing wasabi is preferably 30 wt % or less. Flavor and pungent taste of freshly harvested wasabi may be decreased when the content of alcohol exceeds 30 wt %.

It is preferable that the alcohol-containing wasabi is containing from 1 to 25 wt % of alcohol.

In this case, alcohol-containing wasabi can express flavor and pungent taste of freshly harvested wasabi more strongly.

An alcohol meter may be used for precisely controlling the amount of alcohol impregnated into wasabi. The amount of alcohol incorporated into wasabi can be determined by measuring the amount of alcohol in the external liquid using the alcohol meter. The end point of the contact time between wasabi and alcohol can be determined from the measurement using the alcohol meter.

The temperature for permitting alcohol to impregnate into wasabi is preferably from 0 to 65° C. Since the time required for permitting alcohol to sufficiently impregnate into wasabi may become too long when the temperature is less than 0° C., and the production cost may be increased. When the temperature exceeds 65° C., on the other hand, the work environment may be aggravated due to an increased amount of evaporation of alcohol. Therefore, the temperature is more preferably from 0 to 30° C.

It is preferable that the alcohol-containing wasabi is obtained by the steps comprising:

impregnating the mass of wasabi with alcohol by allowing wasabi to contact alcohol or alcohol aqueous solution; and

allowing wasabi to stand in alcohol at a temperature from 5 to 60° C. for 20 minutes or more.

In this case, flavor and pungent taste of the alcohol-containing wasabi may be further enhanced, since the enzyme reaction advances in alcohol-containing wasabi during the standing time.

Flavor and pungent taste of the alcohol-containing wasabi may be not so sufficiently improved when the standing temperature is less than 5° C. or standing time is less than 20 minutes after impregnation. On the other hand, the amount of expression of flavor and pungent taste may be decreased due to inactivation of the enzyme when the temperature exceeds 60° C.

The amount of expression of flavor and pungent taste is controlled by the standing time and temperature. The amount of expression of flavor and pungent taste reaches maximum in about 20 hours when the alcohol-containing wasabi is made to stand at 5° C. The amount of expression reaches maximum in about 2 hours and about 20 minutes at 22° C. and 60° C., respectively.

An extract solution having flavor and pungent taste of wasabi is obtained as a distilled liquid by distilling the alcohol-containing wasabi.

The alcohol-containing wasabi can be distilled by adding a given quantity of water to the alcohol-containing wasabi placed in a distillation tank with a steam temperature adjusted at 93° C. or more. The amount of charge of wasabi and the amount of addition of water may be determined by taking the composition of the wasabi extract solution into consideration. Specifically, 1 to 10 L of water is added to 10 kg of alcohol-containing wasabi for distillation.

The wasabi extract solution is retrieved, for example, as a liquid chilled with a condenser. The wasabi extract solution is obtained, for example, as an extract solution containing 85 wt % or less of alcohol and 10 wt % or more of water. The quality of flavor and pungent taste can be controlled by fractional collection of distilled fractions obtained by distillation. The amount of pungent taste can be freely controlled by the amount of the alcohol-containing wasabi charged in the distillation tank, by the content of alcohol in the alcohol-containing wasabi and by the volume of the collected distillate.

Since the wasabi extract solution is obtained as a liquid having uniform flavor and pungent taste, it may be used, for example, by adding to wasabi products such as wasabi dressing.

The extract component of wasabi can be precipitated by forming an alcohol aqueous solution containing 30 wt % or less of alcohol by diluting the wasabi extract solution with water with gentle stirring. A wasabi extract from which alcohol and water are removed can be obtained by filtering the precipitate.

The wasabi extract can be used for foods as well as chemical products such as an antibacterial sheet.

### EXAMPLES

### Example 1

Examples of the present invention will be described below.

The alcohol-containing wasabi is produced in this example by impregnating wasabi with alcohol.

Flowers, leaves, stems, rootstocks and roots of wasabi (genuine wasabi) belonging to Wasabia japonica were prepared. These flowers, leaves, stems, rootstocks and roots (100 g each) were weighed and placed in respective 1 L vessels with covers. Ethanol (95%, 30 ml) was added to each vessel, and mixed with stirring at 22° C. for 1 minute. After leaving each vessel at the same temperature for 30 minutes, five samples of alcohol-containing wasabi from the flowers, leaves, stems, rootstocks and roots, respectively were obtained by solid-liquid separation.

The content of alcohol (ethanol) was measured for each alcohol-containing wasabi prepared as described above.

Specifically, water (300 ml) was added to the total amount of each alcohol-containing wasabi followed by distillation to obtain 100 ml of a distillate. Then, the ethanol concentration of each distillate was measured using an alcohol meter to calculate the content of ethanol in the alcohol-containing wasabi. The results are shown in Table 1.

The alcohol contents of flowers, leaves, stems, rootstocks and roots before impregnation of alcohol were also measured for comparison. The results are also shown in Table 1.

### [Table 1]

TABLE 1

content of alcohol in 100 g of wasabi

| part of wasabi | raw wasabi | alcohol-containing wasabi |
|---|---|---|
| flowers | 0 | 20 |
| leaves | 0 | 18 |
| stems | 0 | 20 |
| rootstocks | 0 | 11 |
| roots | 0 | 21 |

Table 1 shows that, while no ethanol was detected in raw wasabi, the alcohol-containing wasabi according to this example of the present invention was impregnated with ethanol.

### Example 2

An alcohol-containing wasabi was produced in an increased scale from the amount in Example 1 in this example.

Roots of Japanese wasabi (1 kg) were placed in a vessel with a cover, and were immersed in 2 L of 40 wt % ethanol aqueous solution for 30 minutes. After immersion, the solid was separated from the liquid to obtain 1 kg of the alcohol-containing wasabi (root).

The alcohol-containing wasabi (100 g) obtained as described above was distilled after adding 300 ml of water to obtain 100 ml of a distillate. The alcohol (ethanol) concentration of the distillate was measured thereafter as in Example 1 using an alcohol meter, and the ethanol content in the alcohol-containing wasabi of this example was calculated. The result showed that the alcohol-containing wasabi of this example contained 16 wt % of ethanol.

According to this example, the alcohol-containing wasabi can be produced simply by impregnate wasabi with alcohol by immersing wasabi in alcohol even in a large scale production using as large as 1 kg of wasabi.

### Example 3

The relation between the temperature and time for impregnating wasabi with alcohol and the amount of alcohol in the alcohol-containing wasabi after impregnation was studied in this example.

Specifically, stems of Japanese wasabi (100 g) was placed in a 1 L vessel with a cover, and 10 ml of ethanol was added at three different temperatures of 5° C., 22° C. and 60° C. Each mixture was stirred for 1 minute after the addition, and was allowed to stand for 30 minutes, 60 minutes and 24 hours, respectively. Plural samples of the alcohol-containing wasabi were produced under different production conditions as described above.

The content of alcohol (ethanol) in each alcohol-containing wasabi was measured by the same method as in Example 1. The results are shown in Table 2.

### [Table 2]

TABLE 2

| | content of ethanol absorbed into | | |
|---|---|---|---|
| | 100 g of wasabi stems | | |
| temperature (° C.) | 30 minutes | 60 minutes | 24 hours |
| 5 | 12 | 18 | 20 |
| 22 | 20 | 20 | 20 |
| 60 | 20 | 20 | 20 |

### Example 4

Pickled wasabi using the alcohol-containing wasabi was produced in this example.

Rootstocks of Japanese wasabi were impregnated with ethanol as in Example 1 to produce the alcohol-containing wasabi (rootstocks).

This alcohol-containing wasabi (500 g) was cut into slices, and the sliced wasabi was pickled in 300 g of sake lees for 2 days by adding 50 g of sugar and a nip of salt. Flavor and pungent taste were evaluated by tasting pickled wasabi thus produced.

Pickled wasabi was also produced using the rootstock of Japanese wasabi before impregnation in alcohol for comparison, and flavor and pungent taste were evaluated by tasting.

The results showed that flavor and pungent taste of wasabi could be sensed merely by holding pickled wasabi using the alcohol-containing wasabi in the mouth. On the contrary, no flavor and pungent taste of wasabi could be sensed merely by holding it in the mouth in pickled wasabi produced by using raw wasabi, and flavor and pungent taste of wasabi could be sensed only by chewing it.

### Example 5

Long term stability of flavor and pungent taste of the alcohol-containing wasabi was investigated in this example.

The alcohol-containing wasabi (rootstocks) was produced by impregnating rootstocks of Japanese wasabi with ethanol by same procedure as example 1.

Grated wasabi was produced by grating 200 g of the alcohol-containing wasabi with a grater, and flavor and pungent taste immediately after grating were evaluated. The grated wasabi was hermetically sealed in a vessel with a cover, and flavor and pungent taste after storing it at 22° C. for 24 hours were evaluated. The results are shown in Table 3.

Grated wasabi was produced as well for comparison using 200 g of rootstocks of Japanese wasabi before being impregnated with alcohol, and flavor and pungent taste were evaluated immediately after grating and after hermetically sealed storage at 22° C. for 24 hours. The results are shown in Table 3.

Flavor and pungent taste were evaluated as follows.

Grated wasabi (100 g) was distilled after adding 100 ml of water, and 100 ml of a distillate was collected. Then, the distillate was optionally diluted with water, and flavor and pungent taste of the liquid were evaluated by holding the liquid in the mouth (sensory test).

### [Table 3]

TABLE 3

| raw material of | flavor and pungent taste | |
|---|---|---|
| grated wasabi | immediately after grating | 24 hours after grating |
| alcohol- | Flavor and pungent taste of | Flavor and pungent taste |
| containing | wasabi could be sensed even | of wasabi could be |
| wasabi | by diluting with water 60 | sensed even by diluting |
| (rootstocks) | times. | 50 times with water. |
| raw wasabi | Flavor and pungent taste of | Stock solution gave |
| (rootstocks) | wasabi could be sensed at | unusual odor and only |
| | 20 times dilution. No | little pungent taste |
| | flavor and pungent taste | could be sensed. |
| | could be sensed at 60 times | |
| | dilution. | |

As shown in Table 3, flavor and pungent taste could be sensed immediately after grating even by diluting with water 60 times when it comes to alcohol-containing wasabi. Flavor and pungent taste could be also sensed after 24 hours even by diluting 50 times with water.

On the contrary, while flavor and pungent taste of wasabi could be sensed at 20 times dilution immediately after grating when it comes to raw wasabi, no flavor and pungent taste could be sensed at 60 times dilution. The stock solution of grated wasabi gave unusual odor after 24 hours, and only little pungent taste could be sensed.

The results of this example show that the alcohol-containing wasabi can exhibit stronger flavor and pungent taste than raw wasabi does while long term stability of flavor and pungent taste is excellent.

### Example 6

The amount of the pungent taste component in the alcohol-containing wasabi was quantified in this example.

Five samples of alcohol-containing wasabi (flowers, leaves, stems, rootstocks and roots) were prepared as in Example 1. Specifically, 30 ml of 95% ethanol aqueous solution was added to each of the flowers, leaves, stems, rootstocks and roots, and mixed at 22° C. for 1 minute with stirring. After allowing each mixture to stand for 30 minutes at the same temperature, samples of alcohol-containing wasabi were prepared by the solid-liquid separation.

Water (300 ml) was added to the total amount of each sample of the alcohol-containing wasabi prepared as described above, and the mixed solution was distilled to obtain 100 ml each of the distillate. Absorbance of the distillate was measured at 260 nm using allyl isothiocyanate as a standard, and the amount of the pungent taste component generated was calculated. The content of alcohol in the alcohol-containing wasabi was also measured using an alcohol meter as in Example 1. The results are shown in Table 4.

The amounts of the pungent taste component generated and the contents of alcohol in the flowers, leaves, stems, rootstocks and roots without being impregnated with alcohol were also measured for comparison. The results are also shown in Table 4.

### [Table 4]

TABLE 4

| | raw wasabi | | alcohol-containing wasabi | |
|---|---|---|---|---|
| | | amounts (g) of the | | amounts (g) of the |
| | amounts (g) | pungent taste | | pungent taste |
| | of ethanol | component generated | amounts (g) of | component generated |
| part of wasabi | in 100 g | in 100 g | ethanol in 100 g | in 100 g |
| flowers | 0 | 0 | 21 | 0.01 |
| leaves | 0 | 0 | 18 | 0.03 |
| stems | 0 | 0 | 18 | 0.02 |
| rootstocks | 0 | 0 | 11 | 0.25 |
| roots | 0 | 0 | 20 | 0.67 |

Table 4 shows that ethanol was detected in each sample of the alcohol-containing wasabi of this example, which showed that wasabi samples of this example contained alcohol. On the contrary, no ethanol was detected in respective portions of raw wasabi (flowers, leaves, stems, rootstocks and roots).

The pungent taste component was detected in the alcohol-containing wasabi. In particular, the alcohol-containing wasabi made from the rootstocks or roots contained the pungent taste at a concentration as high as 0.25 g or more per 100 g. On the contrary, no pungent taste component was detected when raw wasabi was used.

### Example 7

The amount of the pungent taste component after long term storage of the alcohol-containing wasabi at a low temperature (5° C.) was evaluated in this example.

Specifically, 30 ml of 95% ethanol aqueous solution was added to each sample of flowers, leaves, stems, rootstocks and roots, and mixed at 5° C. for 1 minute with stirring. After allowing each sample to stand for 30 hours at the same temperature, five samples of the alcohol-containing wasabi from the flowers, leaves, stems, rootstocks and roots were obtained by the solid-liquid separation.

Each of five samples of alcohol-containing wasabi prepared as described above was placed in a vessel with a cover, and was allowed to stand at 5° C. for 10 days with hermetic sealing.

Water (300 ml) was added to the total amount of each sample of alcohol-containing wasabi thereafter, and the mixture was distilled to obtain 100 ml of the distillate. Absorbance at 260 nm of this distillate was measured as in Example 6 using allyl isothiocyanate as a standard, and the amount of the pungent taste component generated was calculated. The content of alcohol in the alcohol-containing wasabi was also measured using an alcohol meter. The results are shown in Table 5.

Samples of flowers, leaves, stems, rootstocks and roots of raw wasabi before being impregnated with alcohol were also allowed to stand at 5° C. for 10 days for comparison, and the amount of the pungent taste component generated and content of alcohol were measured. The results are shown in Table 5.

### [Table 5]

TABLE 5

| | raw wasabi | | alcohol-containing wasabi | |
|---|---|---|---|---|
| | | amounts (g) of the | | amounts (g) of the |
| | | pungent taste | | pungent taste |
| | amounts (g) of | component generated | amounts (g) of | component generated |
| part of wasabi | ethanol in 100 g | in 100 g | ethanol in 100 g | in 100 g |
| flowers | 0 | 0 | 18 | 0.01 |
| leaves | 0 | 0 | 16 | 0.02 |
| stems | 0 | 0 | 16 | 0.02 |
| rootstocks | 0 | 0 | 15 | 0.33 |
| roots | 0 | 0 | 19 | 0.75 |

Table 5 shows that the alcohol-containing wasabi of this example contained alcohol (ethanol) even after long term storage of as long as 10 days, and the pungent taste component was also detected in the alcohol-containing wasabi. On the contrary, raw wasabi contained no alcohol while no pungent taste component was detected.

### Example 8

The amount of the pungent taste component after storing the alcohol-containing wasabi at a high temperature (60° C.) was evaluated in this example.

Specifically, 30 ml of 95% ethanol aqueous solution was added to each sample of flowers, leaves, stems, rootstocks and roots of Japanese wasabi, and was mixed at 60° C. for 1 minute with stirring. After allowing each sample to stand at the same temperature for 30 hours, five samples of alcohol-containing wasabi from the flowers, leaves, stems, rootstocks and roots were obtained by solid-liquid separation.

Each of the five samples of the alcohol-containing wasabi prepared as described above was placed in a vessel with a cover, and was allowed to stand at 60° C. for 60 minutes with hermetic sealing.

Then, 300 ml of water was added to the total amount of each sample of alcohol-containing wasabi, and the mixture was distilled to obtain 100 ml of a distillate. Absorbance at 260 nm of this distillate was measured using allyl isothiocyanate as a standard, and the amount of the pungent taste component generated was calculated. The content of alcohol in each sample of alcohol-containing wasabi was measured as in Example 1 using an alcohol meter. The results are shown in Table 6.

The amounts of the pungent taste component generated and the content of alcohol in flowers, leaves, stems, rootstocks and roots of raw wasabi before being impregnated with alcohol were also measured after allowing them to stand at 60° C. for 60 minutes. The results are also shown in Table 6.

### [Table 6]

TABLE 6

| | raw wasabi | | alcohol-containing wasabi | |
|---|---|---|---|---|
| | | amounts (g) of the | | amounts (g) of the |
| | | pungent taste | | pungent taste |
| | amounts (g) of | component generated | amounts (g) of | component generated |
| part of wasabi | ethanol in 100 g | in 100 g | ethanol in 100 g | in 100 g |
| flowers | 0 | 0 | 19 | 0.02 |
| leaves | 0 | 0 | 18 | 0.03 |
| stems | 0 | 0 | 16 | 0.02 |
| rootstocks | 0 | 0 | 18 | 0.30 |
| roots | 0 | 0 | 20 | 0.85 |

Table 6 showed that the alcohol-containing wasabi of this example contained alcohol (ethanol) even by storing it at temperature as high as 60° C., and the pungent taste component was also detected in the alcohol-containing wasabi. On the contrary, no pungent taste component was detected in raw wasabi stored under the same condition.

### Example 9

A wasabi extract solution was prepared in this example by distillation of the alcohol-containing wasabi.

Specifically, rootstocks (10 kg) of raw wasabi were placed in a vessel with a cover, and 2 L of 95% ethanol aqueous solution was mixed with the rootstock at 22° C. with stirring for 3 minutes. After allowing the mixture to stand for 30 minutes at the same temperature, the alcohol-containing wasabi (rootstocks) was obtained by solid-liquid separation.

The alcohol-containing wasabi obtained was allowed to stand at 22° C. for 3 days in order to permit flavor and pungent taste to be expressed. The alcohol-containing wasabi was placed in a 20 L distillation tank, and was distilled by adding 2 L of water to obtain 1 L of a distillate (wasabi extract solution). This wasabi extract solution was a colorless and transparent liquid.

The ethanol content of the wasabi extract solution obtained as described above was measured by the same method as in Example 1, and the content of the pungent taste component was also measured by the same method as in Example 6.

The results showed that the wasabi extract solution of this example contained 85 wt % of ethanol, 5 wt % of the pungent taste component and 10 wt % of water.

### Example 10

In this example, a wasabi extract solution was prepared from the alcohol-containing wasabi, and a wasabi extract was prepared from the wasabi extract solution.

Specifically, 10 kg of the alcohol-containing wasabi (rootstocks) was produced by the same method as in Example 9.

The alcohol-containing wasabi thus obtained was then allowed to stand at 22° C. for 2 days to permit flavor and pungent taste to be expressed. The alcohol-containing wasabi was placed in a 20 L distillation tank as in Example 9, and was distilled by adding 2 L of water to obtain 1 L of a distillate (wasabi extract solution). This wasabi extract solution was colorless and transparent liquid.

The ethanol content of the wasabi extract solution thus obtained as described above was measured by the same method as in Example 1, and the content of the pungent taste component was also measured by the same method as in Example 6.

The result showed that the wasabi extract solution of this example contained 71 wt % of ethanol, 15 wt % of the pungent taste component and 14 wt % of water.

Water was added to 1 L of the extract solution in order to adjust the ethanol concentration in the extract solution to 30 wt %. The diluted solution was gently stirred at room temperature to form precipitates. After 30 minutes, the precipitate was filtered using filter paper, and 105 g of the precipitate (wasabi extract) was retrieved on the filter paper.

The wasabi extract (2 g) thus obtained was dissolved by adding 100 ml of 95% ethanol aqueous solution. The content of the pungent taste component in this solution was measured using allyl isothiocyanate as a standard.

The result showed that the extract of this example contained 80 wt % of the pungent taste component.

What is claimed is:

1. An alcohol-containing wasabi prepared by impregnating wasabi with alcohol.

2. The alcohol-containing wasabi according to claim 1, wherein the alcohol is ethanol.

3. The alcohol-containing wasabi according to claim 1, wherein the wasabi belongs to Wasabia japonica and the wasabi is an entire body or a tissue divided into at least one portion selected from flowers, leaves, stems, rootstocks and roots.

4. The alcohol-containing wasabi according to claim 1 containing from 1 to 25 wt % of alcohol.

5. The alcohol-containing wasabi according to claim 1 obtained by the steps comprising:
impregnating the mass of wasabi with alcohol by allowing wasabi to contact alcohol or alcohol aqueous solution; and
allowing wasabi to stand in alcohol at a temperature from 5 to 60° C. for 20 minutes or more.

6. A wasabi extract solution obtained by distilling the alcohol-containing wasabi which is prepared by impregnating wasabi with alcohol.

7. A wasabi extract solution according to claim 6, wherein the alcohol contained in the alcohol-containing wasabi is ethanol.

8. A wasabi extract solution according to claim 6, wherein the wasabi of the alcohol-containing wasabi belongs to Wasabia japonica and the wasabi is an entire body or a tissue divided into at least one portion selected from flowers, leaves, stems, rootstocks and roots.

9. A wasabi extract solution according to claim 6, wherein the alcohol-containing wasabi is containing from 1 to 25 wt % of alcohol.

10. A wasabi extract solution according to claim 6, wherein the alcohol-containing wasabi obtained by the steps comprising:
impregnating the mass of wasabi with alcohol by allowing wasabi to contact alcohol or alcohol aqueous solution; and
allowing wasabi to stand in alcohol at a temperature from 5 to 60° C. for 20 minutes or more.

11. A wasabi extract obtained by the steps comprising:
forming precipitates by diluting a wasabi extract solution with water to an alcohol concentration of 30 wt % or less; and
retrieving the precipitate,
wherein the wasabi extract solution obtained by distilling the alcohol-containing wasabi which is prepared by impregnating wasabi with alcohol.

12. A wasabi extract according to claim 11, wherein the alcohol contained in the alcohol-containing wasabi is ethanol.

13. A wasabi extract according to claim 11, wherein the wasabi of the alcohol-containing wasabi belongs to Wasabia japonica and the wasabi is an entire body or a tissue divided into at least one portion selected from flowers, leaves, stems, rootstocks and roots.

14. A wasabi extract according to claim 11, wherein the alcohol-containing wasabi is containing from 1 to 25 wt % of alcohol.

15. A wasabi extract according to claim 11, wherein the alcohol-containing wasabi obtained by the steps comprising:
impregnating the mass of wasabi with alcohol by allowing wasabi to contact alcohol or alcohol aqueous solution; and
allowing wasabi to stand in alcohol at a temperature from 5 to 60° C. for 20 minutes or more.
